(19) United States
(12) Patent Application Publication
(10) Pub. No.: US 2023/0368289 A1
(43) Pub. Date: Nov. 16, 2023

(54) SYSTEM AND METHOD FOR PROCESSING INSTRUCTIONS ASSOCIATED WITH ONE OR MORE DATA TRANSFERS

(71) Applicant: The Toronto-Dominion Bank, Toronto (CA)

(72) Inventors: Michael James TAGGART, Ottawa (CA); Sam Alexander TURKINGTON, Edmonton (CA)

(21) Appl. No.: 17/740,901

(22) Filed: May 10, 2022

(51) Int. Cl. G06Q 40/02; G06Q 10/10

(52) U.S. Cl. CPC G06Q 40/025; G06Q 10/10

(57) ABSTRACT

Computing platforms, methods, and storage media for processing instructions associated with one or more data transfers are disclosed. Exemplary implementations may: obtain, by a processor, a credit application identifier identifying a pending credit application that involves credit adjudication; identify, in conjunction with an adjudication database and based on the credit application identifier, an adjudication process identifier associated with ownership of a current adjudication task for the pending credit application; automatically generate, based on a role associated with the adjudication process identifier, a status of the pending credit application; and provide, by the processor, the status of the pending credit application. Exemplary implementations may: enable a user to check on and determine the status of one or more credit applications, without needing to contact anyone involved; provide an overview of pending applications for a branch, district or region; and provide data and analytics relating to application processing times or approval rates.

### FIELD

The present disclosure relates to data transfers, including but not limited to computing platforms, methods, and storage media for processing instructions associated with one or more data transfers.

### BACKGROUND

Data transfers can be important in a number of different scenarios. One example is a process in which an individual applies for credit from an institution, often using the assistance of an agent or intermediary associated with the institution. Such a credit application may include, for example, an application for a mortgage or for a credit card.

In a credit application process, once an application has been submitted, the status of the application can be difficult to ascertain. The status information is important to the sales representative who initiated the application, as well as the customer who initiated the request.

The processing of a credit application typically involves a number of different parties, including adjudication, which may be performed by an adjudication processing center. For real estate secured lending (RESL), such as a mortgage, the process also includes appraisal, and in some cases may further include compliance and/or retail risk management.

After a sales representative sends in a credit application for processing, there is currently no way to easily determine the status of the deal, or application. A sales representative can try to telephone someone who may be involved in the process. However, this requires in-depth knowledge of the process, and can be time consuming, unreliable, and disruptive to the sales representative and the person being contacted. This can also create problems for staffing and for providing updates on credit applications.

Improvements in approaches for processing instructions associated with one or more data transfers are desirable.

### BRIEF DESCRIPTION OF THE DRAWINGS

Embodiments of the present disclosure will now be described, by way of example only, with reference to the attached Figures.

FIG. 1 is a block diagram illustrating a system configured for processing instructions associated with one or more data transfers, such as for providing a status of a pending credit application, in accordance with one or more embodiments.

FIG. 2 illustrates a system configured for processing instructions associated with one or more data transfers, such as for providing a status of a pending credit application, in accordance with one or more embodiments.

FIG. 3 illustrates a method for processing instructions associated with one or more data transfers, such as for providing a status of a pending credit application, in accordance with one or more embodiments.

FIG. 4 illustrates an example user interface including status details for a plurality of pending credit applications at a number of districts, in accordance with one or more embodiments.

FIG. 5 illustrates an example user interface including status details for a plurality of pending credit applications for a selected district, in accordance with one or more embodiments.

FIG. 6 illustrates an example user interface including status details for a specific pending credit application, in accordance with one or more embodiments.

FIG. 7 illustrates an example user interface including status details for a specific pending credit application involving a compliance stage, in accordance with one or more embodiments.

### DETAILED DESCRIPTION

Computing platforms, methods, and storage media for processing instructions associated with one or more data transfers are disclosed. Exemplary implementations may: obtain, by a processor, a credit application identifier identifying a pending credit application that involves credit adjudication; identify, in conjunction with an adjudication database and based on the credit application identifier, an adjudication process identifier associated with ownership of a current adjudication task for the pending credit application; automatically generate, based on a role associated with the adjudication process identifier, a status of the pending credit application; and provide, by the processor, the status of the pending credit application. Exemplary implementations may: enable a user to check on and determine the status of one or more credit applications, without needing to contact anyone involved; provide an overview of pending applications for a branch, district or region; and provide data and analytics relating to application processing times or approval rates.

The present disclosure provides a system and method for providing automated status updates on an in-progress credit application that involves adjudication. Embodiments include a tool configured to provide a visual overview of the status of an in-progress credit application that involves adjudication. The status may be determined and/or inferred based on blending data from an adjudication database with an identifier associated with ownership of a current adjudication task for the pending credit application. The tool may be configured to enable a user, such as a credit sales representative, to check on and determine the status of one or more of their credit applications, without needing to contact anyone involved. The tool may also be configured to provide an overview of pending applications for a branch, district or region, and provide data and analytics relating to application processing times, approval rates, etc. In an implementation, the tool may automatically take certain actions, such as re-assigning processing of a credit application, based on such analytics and data.

One aspect of the present disclosure relates to a computing platform configured for processing instructions associated with one or more data transfers. The computing platform may include a non-transient computer-readable storage medium having executable instructions embodied thereon. The computing platform may include one or more hardware processors configured to execute the instructions. The processor(s) may execute the instructions to obtain, by a processor, a credit application identifier identifying a pending credit application that involves credit adjudication. The processor(s) may execute the instructions to identify, in conjunction with an adjudication database and based on the credit application identifier, an adjudication process identifier associated with ownership of a current adjudication task for the pending credit application. The processor(s) may execute the instructions to automatically generate, based on a role associated with the adjudication process identifier, a status of the pending credit application. The processor(s) may execute the instructions to provide, by the processor, the status of the pending credit application.

Another aspect of the present disclosure relates to a method for processing instructions associated with one or more data transfers. The method may include obtaining, by a processor, a credit application identifier identifying a pending credit application that involves credit adjudication. The method may include identifying, in conjunction with an adjudication database and based on the credit application identifier, an adjudication process identifier associated with ownership of a current adjudication task for the pending credit application. The method may include automatically generating, based on a role associated with the adjudication process identifier, a status of the pending credit application. The method may include providing, by the processor, the status of the pending credit application.

Yet another aspect of the present disclosure relates to a non-transient computer-readable storage medium having instructions embodied thereon, the instructions being executable by one or more processors to perform a method for processing instructions associated with one or more data transfers. The method may include obtaining, by a processor, a credit application identifier identifying a pending credit application that involves credit adjudication. The method may include identifying, in conjunction with an adjudication database and based on the credit application identifier, an adjudication process identifier associated with ownership of a current adjudication task for the pending credit application. The method may include automatically generating, based on a role associated with the adjudication process identifier, a status of the pending credit application. The method may include providing, by the processor, the status of the pending credit application.

For the purpose of promoting an understanding of the principles of the disclosure, reference will now be made to the features illustrated in the drawings and specific language will be used to describe the same. It will nevertheless be understood that no limitation of the scope of the disclosure is thereby intended. Any alterations and further modifications, and any further applications of the principles of the disclosure as described herein are contemplated as would normally occur to one skilled in the art to which the disclosure relates. It will be apparent to those skilled in the relevant art that some features that are not relevant to the present disclosure may not be shown in the drawings for the sake of clarity.

Certain terms used in this application and their meaning as used in this context are set forth in the description below. To the extent a term used herein is not defined, it should be given the broadest definition persons in the pertinent art have given that term as reflected in at least one printed publication or issued patent. Further, the present processes are not limited by the usage of the terms shown below, as all equivalents, synonyms, new developments and terms or processes that serve the same or a similar purpose are considered to be within the scope of the present disclosure.

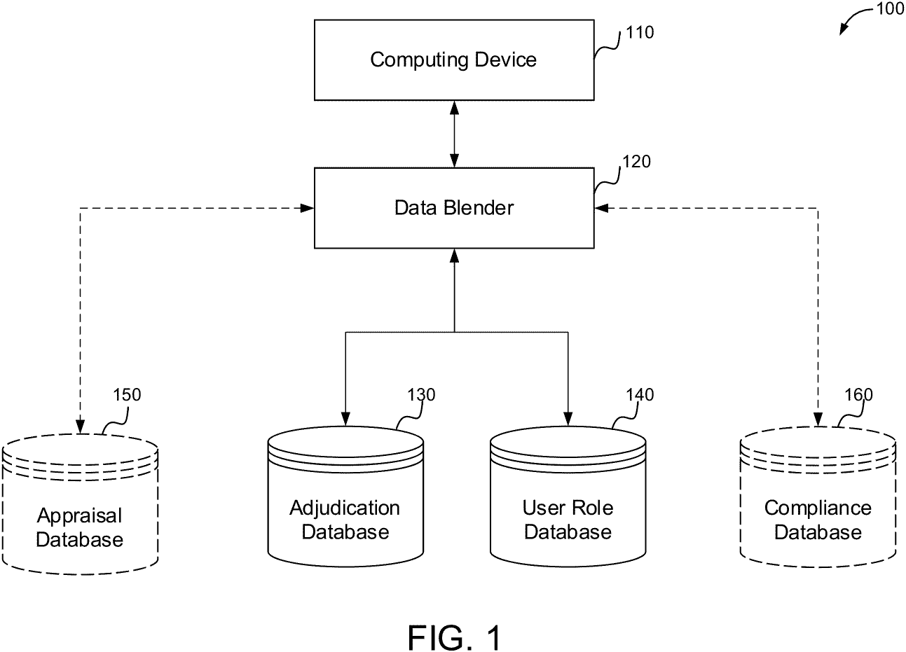

FIG. 1 is a block diagram illustrating a system 100 according to an embodiment of the present disclosure media for processing instructions associated with one or more data transfers, such as for providing a status of a pending credit application. A computing device 110 is in communication with a data blender 120. The computing device 110 may be associated with a sales channel representative, mobile mortgage advisor, or any other person who may initiate or enter details for a credit application that involves adjudication. The data blender 120 is in communication with the computing device 110, as well as with an adjudication database 130 and a user role database 140, and optionally an appraisal database 150 and/or a compliance database 160.

The data blender 120 may comprise a server, such as a SQL server. The data blender 120 may include a non-transient computer-readable storage medium having executable instructions embodied thereon, and one or more hardware processors. The processor(s) may be configured to execute the instructions to: obtain, by the data blender 120, a credit application identifier identifying a pending credit application that involves credit adjudication; identify, in conjunction with the adjudication database 130 and based on the credit application identifier, an adjudication process identifier associated with ownership of a current adjudication task for the pending credit application; determine, based on a role associated with the adjudication process identifier, a status of the pending credit application; and provide, by the data blender 120, the status of the pending credit application.

Embodiments of the disclosure make it simpler to obtain information on the status of a credit application that is in-process. The embodiments are intended to answer: “Where is my deal?” or “What is the status of my application?” without anyone needing to take their minds off of their work by having to answer individual requests. Also, for a commissioned sales person, there is an incentive to have good and timely answers on credit application status.

An embodiment of the present disclosure may be applied to mobile mortgage services to look at different deals, and give updates on the status of different mortgage requests. One embodiment may be implemented for Real Estate Secured Lending (RESL), such as mortgages, home equity line of credit, and flex lines. Another embodiment may be extended to unsecured lending, unsecured lines of credit, car loans, student lines of credit, cards, or any request for credit from the sales channel. All items are instances where either someone has walked into a branch, or mobile mortgage and requested credit for some reason. In such implementations, instead of data going through a real estate adjudication centre, the data and process goes through other adjudication centre, for example an adjudication centre for credit cards. Different implementations have the following in common: sending a credit application to a credit centre for adjudication; the adjudication centre sends back an answer at the end of the process; and the time in between is considered somewhat of a black box, where not much information is available.

Typically, requests are packaged by the sales channel and sent to adjudication, for example including an adjudication database 130. In an embodiment, the system is used internally by the sales channel to view information about how their request is being handled/processed. In another embodiment, a client-facing version provides similar information to a client initiating the request/application.

The system 100 enables a sales channel representative to view all the deals they have submitted and see the status of those deals. The system 100 helps to find individual deals, and provides the ability to look at an individual branch or region. A district manager can also look at a plurality of pending credit applications at a high level, and also explore details for a specific item, for example a rush request. The data on status and processing times may be used for coaching opportunities. An embodiment configured for mobile mortgage sales (MMS) has ability to see whether or not an application has been approved.

In an embodiment, the data blender 120 and/or the user role database 140 may be responsible for data access permissions, or may cooperate to manage data access permissions. Data access permissions may be managed by a server, such as a Tableau server, and managed by active directory group in Windows. For example, if a user needs to access the system, the user needs a particular uniform resource locator (URL), and also the active directory may need to confirm that the user has the requisite permissions. In an implementation, the system 100 may manage separate active directories for each of a plurality of user groups, for example credit centre, MMS, branch managers, sales managers. In an example implementation, a user is provisioned first to be granted access to application status information, and even then a user may only have access to specific data that is relevant to the user and the access granted to the user.

Typically, the only other way that a sales representative would have any access to this data is through manual updates or system generated updates for milestones.

In known approaches, a sales representative submits a credit file for review, and waits a few weeks for someone to pick up the application. The person processing the application may or may not email the sales representative with the status. After that point, the application may go up to RRM (retail risk management), may get escalated, or may go back and forth in a deliberation process. The sales representative may or may not get one email communication, and otherwise they are only informed of the decision at the very end.

Embodiments of the present disclosure provide almost real-time access, or near real-time access, to status information associated with a pending credit application, as well as the ability to drill down and sort or filter, depending on role.

The system 100 may obtain data from one or more data sources, for example an internal SQL server for processing. The system 100 advantageously blends information from different databases, including one or more of: adjudication database 130; user role database 140; appraisal database 150; and/or compliance database 160. In an implementation, the system 100 may be configured to run a data extraction at a regular interval, for example about every 15 minutes, blend the data, and provide an indication, such as a user interface or a visual display, indicating the status of the pending credit application(s).

In an implementation, the system 100 may identify the current status based on blending of data. For example, the blending may comprise user hierarchy data blending, such as in conjunction with the user role database 140, to identify if someone has ownership of an active task associated with the pending credit application, and identify the role of that person, and infer the status based on the role of the person with the active task. In other embodiments, a similar data blending is performed for an RRM step, and for compliance data blending.

In an example implementation, the data blending occurs in a SQL server, and is published onto a Tableau server. The tableau/CCO server linkage may be live. Any time someone accesses a dashboard associated with the system 100, the Tableau server may obtain the associated data. In an example implementation, there may be a variety of upstream sources, which may be blended in the SQL server, published via live connection to Tableau server, and made available on the web.

In an embodiment of the present disclosure adapted for a retail implementation, the system 100 may start with a list of deals currently in progress or decisioned in a particular time period, for example the last 30 days. While there is no compliance process for retail, the process includes data blending from appraisal and adjudication. Embodiments of the present disclosure may layer in data from a number of reference tables, or user role databases such as user role database 140, including branch hierarchies, and string the information into districts and regions. In an implementation, the system 100 may also layer in an adjudication reference table and determine if the person who currently owns the deal, or the active task, is an analyst, since there are a number of people whose job is not to adjudicate.

Based on the assigned role of the person currently assigned to an active task for the deal, the system 100 is configured to discern a status of the pending credit application, for example based on whether or not the role of the person is a role of an adjudicator.

A similar layering may be provided for risk tasks provided by a risk team. Where an aspect of a credit application is not standard or does not meet lending guidelines, or if someone still thinks the application is still worth going ahead, a credit application may be escalated to a risk group. A retail risk management (RRM) group may be a subset of the adjudication process; only specific deals will need to be escalated to RRM. Implementations of the system 100 may be configured to layer in additional data about RRM, for example whether the person associated with an active task is an administrator, or credit adjudicator.

A commonality between different implementations of the system 100 is the data layer from the appraisal services team. A database may contain workflow information relating to the credit application. The database may indicate that the item has gone through the adjudication process, but is currently sitting with the appraisal services group.

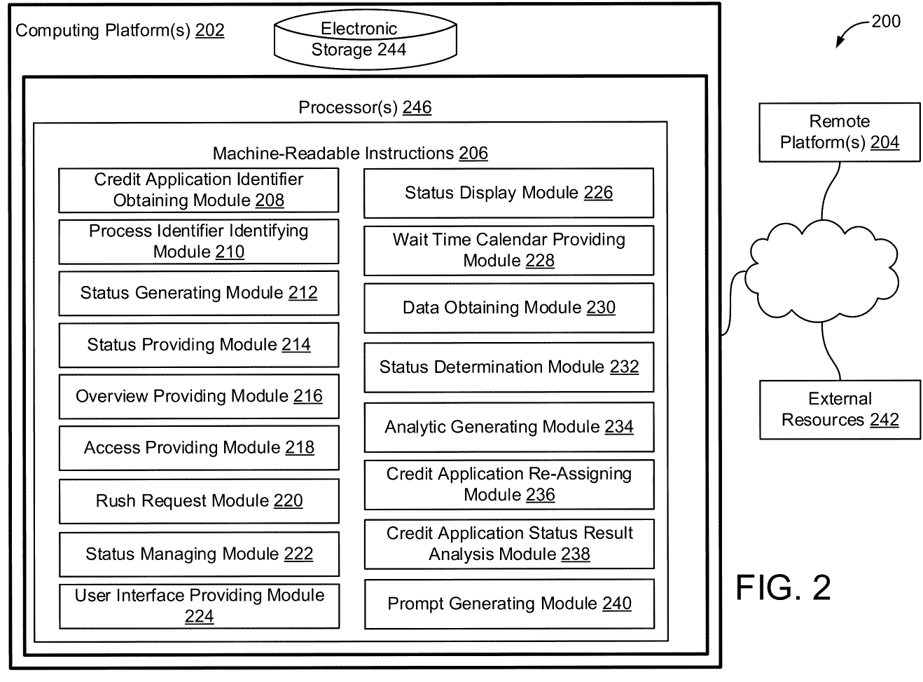

FIG. 2 illustrates a system 200 configured for processing instructions associated with one or more data transfers, such as providing a status of a pending credit application, in accordance with one or more embodiments. In some embodiments, system 200 may include one or more computing platforms 202. Computing platform(s) 202 may be configured to communicate with one or more remote platforms 204 according to a client/server architecture, a peer-to-peer architecture, and/or other architectures. Remote platform(s) 204 may be configured to communicate with other remote platforms via computing platform(s) 202 and/or according to a client/server architecture, a peer-to-peer architecture, and/or other architectures. Users may access system 200 via remote platform(s) 204.

Computing platform(s) 202 may be configured by machine-readable instructions 206. Machine-readable instructions 206 may include one or more instruction modules. The instruction modules may include computer program modules. The instruction modules may include one or more of credit application identifier obtaining module 208, process identifier identifying module 210, status generating module 212, status providing module 214, overview providing module 216, access providing module 218, rush request module 220, status managing module 222, user interface providing module 224, status display module 226, wait time calendar providing module 228, data obtaining module 230, status determination module 232, analytic generating module 234, credit application re-assigning module 236, credit application status result analysis module 238, prompt generating module 240, and/or other instruction modules.

Credit application identifier obtaining module 208 may be configured to obtain, by a processor, a credit application identifier identifying a pending credit application that involves credit adjudication. The credit application identifier may be a numerical identifier, an alphanumeric identifier, or some other type of identifier that is preferably unique, or at least unique within a certain time period. The pending credit application may be associated with a real estate secured lending mortgage. The pending credit application may be associated with a retail risk management.

Process identifier identifying module 210 may be configured to identify, in conjunction with an adjudication database and based on the credit application identifier, an adjudication process identifier associated with ownership of a current adjudication task for the pending credit application. The current adjudication task may be among a plurality of tasks associated with the pending credit application. Process identifier identifying module 210 may be in communication with one or more other entities, for example such as the user role database 140 of FIG. 1.

Status generating module 212 may be configured to automatically generate, based on a role associated with the adjudication process identifier, a status of the pending credit application. Automatically generating the status of the pending credit application may include determining whether the adjudication process is complete for the pending credit application. Automatically generating the status of the pending credit application may include determining whether the credit application is with retail risk management (RRM) or whether the credit application is with RRM but assigned to a credit analyst. Status generating module 212 may be in communication with one or more other entities, for example such as the user role database 140 of FIG. 1.

Status generating module 212 may be configured to automatically generate the status of the pending credit application based on the role associated with the adjudication process identifier and on the ownership of the current adjudication task. Status generating module 212 may be configured to automatically generate the status of the pending credit application based on blending data from an adjudication database with the adjudication process identifier.

Status providing module 214 may be configured to provide, by the processor, the status of the pending credit application, for example to a user via a user interface and including a visual, textual or other representation of the status.

Overview providing module 216 may be configured to provide a visual overview of the status of the pending credit application to a computing device associated with a sales representative involved with the credit application. Overview providing module 216 may be configured to provide a visual overview of the status of the pending credit application to a computing device associated with an applicant involved with the credit application. Overview providing module 216 may be configured to provide a graphical, textual, auditory, vibratory or other indication of the status of the pending credit application to a computing device associated with a sales representative or applicant involved with the credit application.

Access providing module 218 may be configured to provide near real-time access to the status of the pending credit application, including access to details associated with the status. Access providing module 218 may be in communication with one or more other entities, for example such as the user role database 140 of FIG. 1, to perform data access management or manage data access permissions.

Rush request module 220 may be configured to provide a display including a rush request button configured to receive a request to rush the pending credit application currently being viewed.

Status managing module 222 may be configured to manage data access permissions associated with the status of the pending credit application. Status managing module 222 may be in communication with one or more other entities, for example such as the user role database 140 of FIG. 1, to perform data access management or manage data access permissions.

User interface providing module 224 may be configured to provide a user interface including the status of the pending credit application and based on the data access permissions. User interface providing module 224 may be configured to provide a user interface via which the status of a plurality of pending credit applications may be filtered by one or more filtering factors such as deal type, complexity and rush.

Status display module 226 may be configured to display the status of a plurality of pending credit applications associated with one or more of a user, a branch, a district, or a region. By way of non-limiting example, the user may include a financial institution sales representative, a financial institution manager, or a mortgage broker.

Wait time calendar providing module 228 may be configured to provide a current wait time calendar indicating wait times associated with the plurality of pending credit applications.

Data obtaining module 230 may be configured to obtain data associated with the pending credit application from one or more data sources.

Status determination module 232 may be configured to automatically determine the status of the pending credit application based on the role associated with the adjudication process identifier and based on one or more of a compliance process identifier associated with ownership of a current compliance task for the pending credit application and an appraisal process identifier associated with ownership of a current appraisal task for the pending credit application.

Analytic generating module 234 may be configured to generate, based on stored credit application status results, analytics relating to a plurality of credit applications including one or more of performance, statistics, approval rates and delays. In addition to monitoring, embodiments of the present disclosure may be used for analytics to produce data relating to performance, statistics, approval rates and delays. In an implementation, the embodiments leverage automation. For example, based on the analytics and statistics, in an embodiment the system may automate one or more aspects of the status update process, or of the credit application process itself. For example, if one particular underwriter is less busy, the system may automatically assign one or more other pending credit applications to that particular underwriter. In addition with respect to analytics, the system may analyze by individual sales representatives and see the number of deals, and the results of deals, such as the percent approval. The data can then be used to determine or provide insight with respect to how processes can be improved, how to measure and/or reward performance, how to help colleagues improve by observing data associated with high performing sales representatives.

Credit application re-assigning module 236 may be configured to, for a first credit application currently assigned to a first underwriter, automatically re-assign the first credit application to a second underwriter based on stored credit application status results associated with either the first underwriter or the second underwriter.

Credit application status result analysis module 238 may be configured to analyze the stored credit application status results with respect to a plurality of sales representatives to determine deal volume, deal results, or percent approval.

Prompt generating module 240 may be configured to generate performance data including one or more performance enhancement prompts based on the analyzed stored credit application status results. For example, a performance enhancement prompt may include a prompt for a credit adjudicator to take one or more actions to improve timeliness or improve a processing rate. This may include a prompt to follow steps performed by a colleague with a higher efficiency or rate of processing, based on analysis of data associated with processing of the colleague’s pending credit applications over a period of time, as compared to analysis of the credit adjudicator’s pending credit applications over the same period of time.

In some embodiments, computing platform(s) 202, remote platform(s) 204, and/or external resources 242 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 202, remote platform(s) 204, and/or external resources 242 may be operatively linked via some other communication media.

A given remote platform 204 may include one or more processors configured to execute computer program modules. The computer program modules may be configured to enable an expert or user associated with the given remote platform 204 to interface with system 200 and/or external resources 242, and/or provide other functionality attributed herein to remote platform(s) 204. By way of non-limiting example, a given remote platform 204 and/or a given computing platform 202 may include one or more of a server, a desktop computer, a laptop computer, a handheld computer, a tablet computing platform, a NetBook, a Smartphone, a gaming console, and/or other computing platforms.

External resources 242 may include sources of information outside of system 200, external entities participating with system 200, and/or other resources. In some embodiments, some or all of the functionality attributed herein to external resources 242 may be provided by resources included in system 200.

Computing platform(s) 202 may include electronic storage 244, one or more processors 246, and/or other components. Computing platform(s) 202 may include communication lines, or ports to enable the exchange of information with a network and/or other computing platforms. Illustration of computing platform(s) 202 in FIG. 2 is not intended to be limiting. Computing platform(s) 202 may include a plurality of hardware, software, and/or firmware components operating together to provide the functionality attributed herein to computing platform(s) 202. For example, computing platform(s) 202 may be implemented by a cloud of computing platforms operating together as computing platform(s) 202.

Electronic storage 244 may comprise non-transitory storage media that electronically stores information. The electronic storage media of electronic storage 244 may include one or both of system storage that is provided integrally (i.e., substantially non-removable) with computing platform(s) 202 and/or removable storage that is removably connectable to computing platform(s) 202 via, for example, a port (e.g., a USB port, a firewire port, etc.) or a drive (e.g., a disk drive, etc.). Electronic storage 244 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 244 may include one or more virtual storage resources (e.g., cloud storage, a virtual private network, and/or other virtual storage resources). Electronic storage 244 may store software algorithms, information determined by processor(s) 246, information received from computing platform(s) 202, information received from remote platform(s) 204, and/or other information that enables computing platform(s) 202 to function as described herein.

Processor(s) 246 may be configured to provide information processing capabilities in computing platform(s) 202. As such, processor(s) 246 may include one or more of a digital processor, an analog processor, a digital circuit designed to process information, an analog circuit designed to process information, a state machine, and/or other mechanisms for electronically processing information. Although processor(s) 246 is shown in FIG. 2 as a single entity, this is for illustrative purposes only. In some embodiments, processor(s) 246 may include a plurality of processing units. These processing units may be physically located within the same device, or processor(s) 246 may represent processing functionality of a plurality of devices operating in coordination. Processor(s) 246 may be configured to execute modules 208, 210, 212, 214, 216, 218, 220, 222, 224, 226, 228, 230, 232, 234, 236, 238, and/or 240, and/or other modules. Processor(s) 246 may be configured to execute modules 208, 210, 212, 214, 216, 218, 220, 222, 224, 226, 228, 230, 232, 234, 236, 238, and/or 240, and/or other modules by software; hardware; firmware; some combination of software, hardware, and/or firmware; and/or other mechanisms for configuring processing capabilities on processor(s) 246. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 208, 210, 212, 214, 216, 218, 220, 222, 224, 226, 228, 230, 232, 234, 236, 238, and/or 240 are illustrated in FIG. 2 as being implemented within a single processing unit, in embodiments in which processor(s) 246 includes multiple processing units, one or more of modules 208, 210, 212, 214, 216, 218, 220, 222, 224, 226, 228, 230, 232, 234, 236, 238, and/or 240 may be implemented remotely from the other modules. The description of the functionality provided by the different modules 208, 210, 212, 214, 216, 218, 220, 222, 224, 226, 228, 230, 232, 234, 236, 238, and/or 240 described below is for illustrative purposes, and is not intended to be limiting, as any of modules 208, 210, 212, 214, 216, 218, 220, 222, 224, 226, 228, 230, 232, 234, 236, 238, and/or 240 may provide more or less functionality than is described. For example, one or more of modules 208, 210, 212, 214, 216, 218, 220, 222, 224, 226, 228, 230, 232, 234, 236, 238, and/or 240 may be eliminated, and some or all of its functionality may be provided by other ones of modules 208, 210, 212, 214, 216, 218, 220, 222, 224, 226, 228, 230, 232, 234, 236, 238, and/or 240. As another example, processor(s) 246 may be configured to execute one or more additional modules that may perform some or all of the functionality attributed below to one of modules 208, 210, 212, 214, 216, 218, 220, 222, 224, 226, 228, 230, 232, 234, 236, 238, and/or 240.

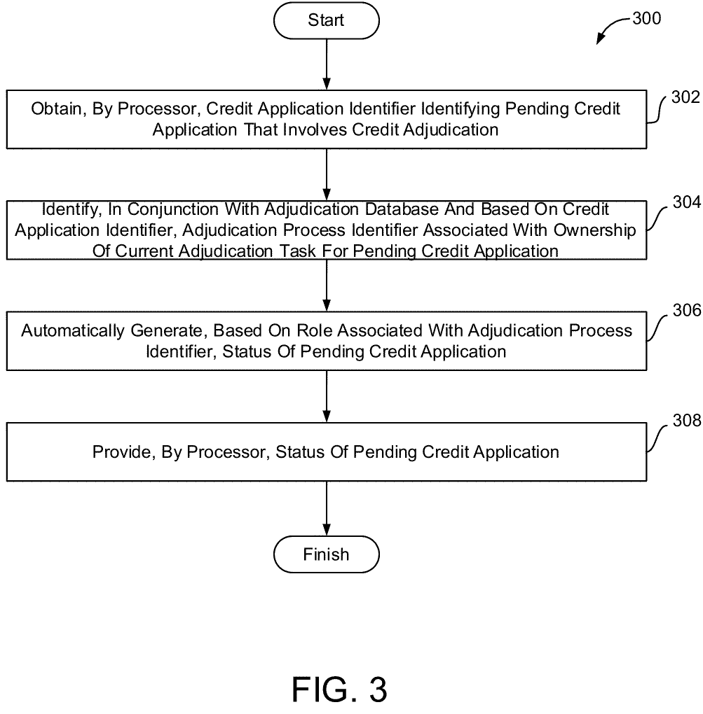

FIG. 3 illustrates a method 300 for processing instructions associated with one or more data transfers, such as providing a status of a pending credit application, in accordance with one or more embodiments. The operations of method 300 presented below are intended to be illustrative. In some embodiments, method 300 may be accomplished with one or more additional operations not described, and/or without one or more of the operations discussed. Additionally, the order in which the operations of method 300 are illustrated in FIG. 3 and described below is not intended to be limiting.

In some embodiments, method 300 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 300 in response to instructions stored electronically on an electronic storage medium. The one or more processing devices may include one or more devices configured through hardware, firmware, and/or software to be specifically designed for execution of one or more of the operations of method 300.

An operation 302 may include obtaining, by a processor, a credit application identifier identifying a pending credit application that involves credit adjudication. Operation 302 may be performed by one or more hardware processors configured by machine-readable instructions including a module that is the same as or similar to credit application identifier obtaining module 208, in accordance with one or more embodiments.

An operation 304 may include identifying, in conjunction with an adjudication database and based on the credit application identifier, an adjudication process identifier associated with ownership of a current adjudication task for the pending credit application. Operation 304 may be performed by one or more hardware processors configured by machine-readable instructions including a module that is the same as or similar to process identifier identifying module 210, in accordance with one or more embodiments.

An operation 306 may include automatically generating, based on a role associated with the adjudication process identifier, a status of the pending credit application. Operation 306 may be performed by one or more hardware processors configured by machine-readable instructions including a module that is the same as or similar to status generating module 212, in accordance with one or more embodiments.

An operation 308 may include providing, by the processor, the status of the pending credit application. Operation 308 may be performed by one or more hardware processors configured by machine-readable instructions including a module that is the same as or similar to status providing module 214, in accordance with one or more embodiments.

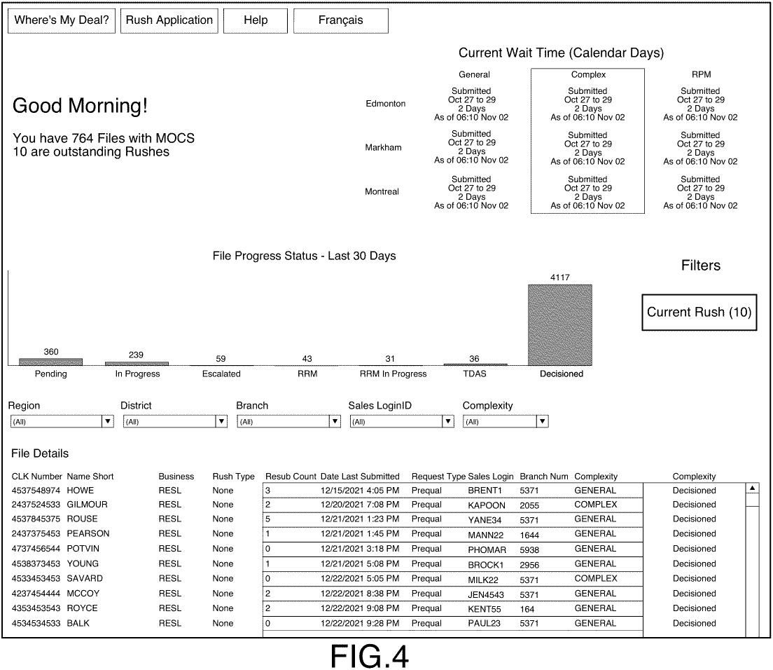

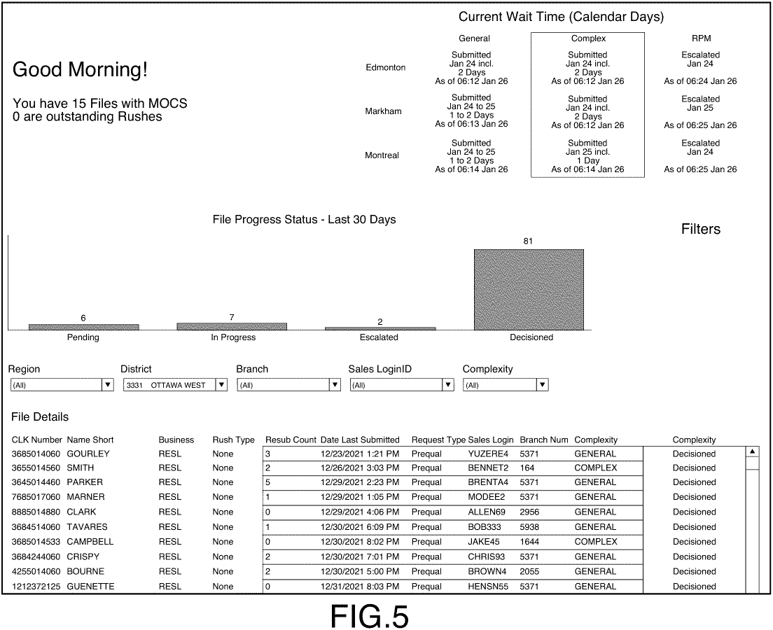

FIG. 4 illustrates an example user interface including status details for a plurality of pending credit applications at a number of districts and branches, in accordance with one or more embodiments. In an implementation, the present disclosure provides a current wait time calendar, such as shown in FIGS. 4 and 5. In an embodiment, the current wait time calendar may be generated based on a calculation or a determination relating to the age of pending credit applications, for example how old the oldest pending credit application or deal is. In another embodiment, the data in the current wait time calendar may be at least partly self-reported and collected.

FIG. 5 illustrates an example user interface including status details for a plurality of pending credit applications for a selected district, in accordance with one or more embodiments. The user interface shown in FIG. 5 may be generated by applying one or more filter criteria or selection criteria to the status details shown in a user interface similar to that shown in FIG. 4.

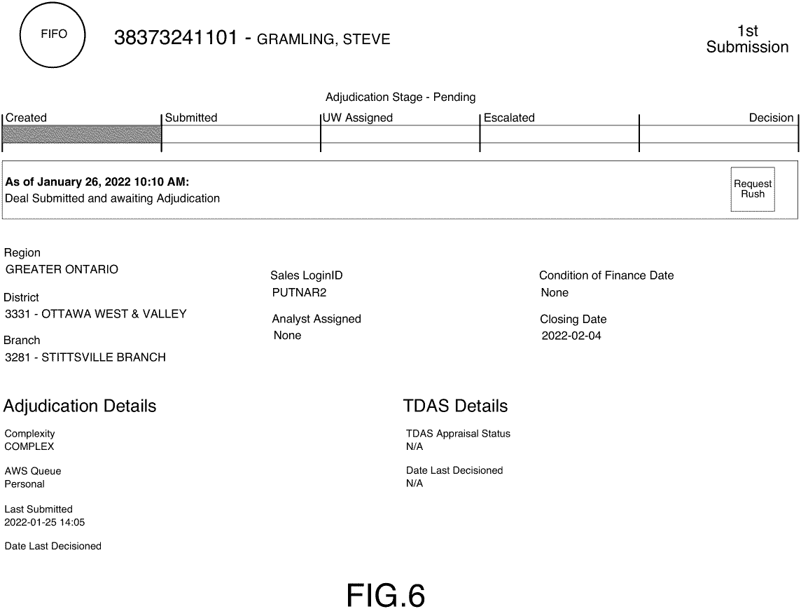

FIG. 6 illustrates an example user interface including status details for a specific pending credit application, in accordance with one or more embodiments. One of the features illustrated in relation to FIG. 6 is the ability to rush a deal in the screen. For example, a user interface may provide a means to rush a deal currently being viewed, such as a deal rush selector. In an implementation, a user can click on a button, such as the Request Rush button shown in FIG. 6, which can in turn generate the instructions to initiate an automated rush request. The implementation in FIG. 6 is an example of a user interface which may be referred to as “Where’s my application” or “Where’s my deal”, which provides a visual and/or textual indicator associated with the status of a pending credit application. As shown in the example in FIG. 6, the user interface may identify the deal request, or pending credit application, for example by number or by another unique identifier.

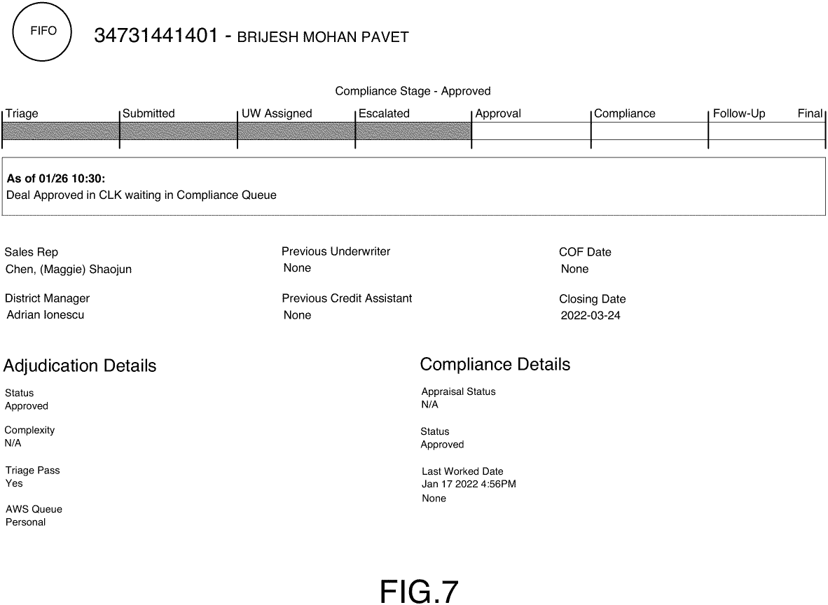

FIG. 7 illustrates an example user interface including status details for a specific pending credit application involving a compliance stage, in accordance with one or more embodiments. In a mobile mortgage services (MMS) implementation of an embodiment of the present disclosure, the data may be blended with a compliance database, and the compliance information may be provided in the status information, such as displayed visually in FIG. 7. An MMS implementation includes a number of steps in the compliance process. For example, there may be a difference in who completes the compliance process depending on the nature of the pending credit application. In a real estate implementation, the process may be complex, and involves validating a number of different elements.

For example, suppose someone applies for mortgage, and earns income of $75k per year. That credit application applicant may be asked to prove their salary, for example by providing a pay stub, direct deposit information, etc. Some branches of credit granting institutions have decided to perform that stage themselves through a delegate in the branch, which may be specialized role, and do not have conflict of interest between sales person and underlying data. When this function is performed in the branch, it is not performed by the credit adjudication centres, and therefore there may not be available data associated with this function, in contrast to the adjudication database when the functionality is centralized. In such an embodiment, the compliance process is in the MMS space, so it has been delegated to credit adjudication centre.

As described herein, the present disclosure provides a system and method for providing automated status updates on an in-progress credit application that involves adjudication. Embodiments include a tool configured to provide a visual overview of the status of an in-progress credit application that involves adjudication. The status may be determined and/or inferred based on blending data from an adjudication database with an identifier associated with ownership of a current adjudication task for the pending credit application. The tool may be configured to enable a user, such as a credit sales representative, to check on and determine the status of one or more of their credit applications, without needing to contact anyone involved. The tool may also be configured to provide an overview of pending applications for a branch, district or region, and provide data and analytics relating to application processing times, approval rates, etc. In an implementation, the tool may automatically take certain actions, such as re-assigning processing of a credit application, based on such analytics and data.

In the preceding description, for purposes of explanation, numerous details are set forth in order to provide a thorough understanding of the embodiments. However, it will be apparent to one skilled in the art that these specific details are not required. In other instances, well-known electrical structures and circuits are shown in block diagram form in order not to obscure the understanding. For example, specific details are not provided as to whether the embodiments described herein are implemented as a software routine, hardware circuit, firmware, or a combination thereof.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a compact disk read only memory (CD-ROM), digital versatile disk (DVD), Blu-ray Disc Read Only Memory (BD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art without departing from the scope, which is defined solely by the claims appended hereto.

Embodiments of the disclosure can be described with reference to the following CLAUSES, with specific features laid out in the dependent clauses:

One aspect of the present disclosure relates to a system configured for processing instructions associated with one or more data transfers. The system may include one or more hardware processors configured by machine-readable instructions. The processor(s) may be configured to obtain, by a processor, a credit application identifier identifying a pending credit application that involves credit adjudication. The processor(s) may be configured to identify, in conjunction with an adjudication database and based on the credit application identifier, an adjudication process identifier associated with ownership of a current adjudication task for the pending credit application. The processor(s) may be configured to automatically generate, based on a role associated with the adjudication process identifier, a status of the pending credit application. The processor(s) may be configured to provide, by the processor, the status of the pending credit application.

In some implementations of the system, the processor(s) may be configured to automatically generate the status of the pending credit application based on the role associated with the adjudication process identifier and on the ownership of the current adjudication task.

In some implementations of the system, the processor(s) may be configured to automatically generate the status of the pending credit application based on blending data from an adjudication database with the adjudication process identifier.

In some implementations of the system, the processor(s) may be configured to provide a visual overview of the status of the pending credit application to a computing device associated with a sales representative involved with the credit application.

In some implementations of the system, the processor(s) may be configured to provide a visual overview of the status of the pending credit application to a computing device associated with an applicant involved with the credit application.

In some implementations of the system, the processor(s) may be configured to provide near real-time access to the status of the pending credit application including access to details associated with the status.

In some implementations of the system, the processor(s) may be configured to provide a display including a rush request button configured to receive a request to rush the pending credit application currently being viewed.

In some implementations of the system, the processor(s) may be configured to manage data access permissions associated with the status of the pending credit application. In some implementations of the system, the processor(s) may be configured to provide a user interface including the status of the pending credit application and based on the data access permissions.

In some implementations of the system, the processor(s) may be configured to display the status of a plurality of pending credit applications associated with one or more of a user, a branch, a district, or a region.

In some implementations of the system, the processor(s) may be configured to provide a current wait time calendar indicating wait times associated with the plurality of pending credit applications.

In some implementations of the system, the user may include a financial institution sales representative, a financial institution manager, or a mortgage broker.

In some implementations of the system, the processor(s) may be configured to provide a user interface via which the status of a plurality of pending credit applications may be filtered by one or more filtering factors such as deal type, complexity and rush.

In some implementations of the system, the processor(s) may be configured to obtain data associated with the pending credit application from one or more data sources.

In some implementations of the system, the processor(s) may be configured to automatically determine the status of the pending credit application based on the role associated with the adjudication process identifier and based on one or more of a compliance process identifier associated with ownership of a current compliance task for the pending credit application and an appraisal process identifier associated with ownership of a current appraisal task for the pending credit application.

In some implementations of the system, the processor(s) may be configured to generate, based on stored credit application status results, analytics relating to a plurality of credit applications including one or more of performance, statistics, approval rates and delays.

In some implementations of the system, the processor(s) may be configured to, for a first credit application currently assigned to a first underwriter, automatically re-assign the first credit application to a second underwriter based on stored credit application status results associated with either the first underwriter or the second underwriter.

In some implementations of the system, the processor(s) may be configured to analyze the stored credit application status results with respect to a plurality of sales representatives to determine deal volume, deal results, or percent approval.

In some implementations of the system, the processor(s) may be configured to generate performance data including one or more performance enhancement prompts based on the analyzed stored credit application status results.

In some implementations of the system, the pending credit application may be associated with a real estate secured lending mortgage. In some implementations of the system, automatically generating the status of the pending credit application may include determining whether the adjudication process is complete for the pending credit application.

In some implementations of the system, the pending credit application may be associated with a retail risk management. In some implementations of the system, automatically generating the status of the pending credit application may include determining whether the credit application is with RRM or whether the credit application is with RRM but assigned to a credit analyst.

Another aspect of the present disclosure relates to a method for processing instructions associated with one or more data transfers. The method may include obtaining, by a processor, a credit application identifier identifying a pending credit application that involves credit adjudication. The method may include identifying, in conjunction with an adjudication database and based on the credit application identifier, an adjudication process identifier associated with ownership of a current adjudication task for the pending credit application. The method may include automatically generating, based on a role associated with the adjudication process identifier, a status of the pending credit application. The method may include providing, by the processor, the status of the pending credit application.

In some implementations of the method, it may include automatically generating the status of the pending credit application based on the role associated with the adjudication process identifier and on the ownership of the current adjudication task.

In some implementations of the method, it may include automatically generating the status of the pending credit application based on blending data from an adjudication database with the adjudication process identifier.

In some implementations of the method, it may include providing a visual overview of the status of the pending credit application to a computing device associated with a sales representative involved with the credit application.

In some implementations of the method, it may include providing a visual overview of the status of the pending credit application to a computing device associated with an applicant involved with the credit application.

In some implementations of the method, it may include providing near real-time access to the status of the pending credit application including access to details associated with the status.

In some implementations of the method, it may include providing a display including a rush request button configured to receive a request to rush the pending credit application currently being viewed.

In some implementations of the method, it may include managing data access permissions associated with the status of the pending credit application. In some implementations of the method, it may include providing a user interface including the status of the pending credit application and based on the data access permissions.

In some implementations of the method, it may include displaying the status of a plurality of pending credit applications associated with one or more of a user, a branch, a district, or a region.

In some implementations of the method, it may include providing a current wait time calendar indicating wait times associated with the plurality of pending credit applications.

In some implementations of the method, the user may include a financial institution sales representative, a financial institution manager, or a mortgage broker.

In some implementations of the method, it may include providing a user interface via which the status of a plurality of pending credit applications may be filtered by one or more filtering factors such as deal type, complexity and rush.

In some implementations of the method, it may include obtaining data associated with the pending credit application from one or more data sources.

In some implementations of the method, it may include automatically determining the status of the pending credit application based on the role associated with the adjudication process identifier and based on one or more of a compliance process identifier associated with ownership of a current compliance task for the pending credit application and an appraisal process identifier associated with ownership of a current appraisal task for the pending credit application.

In some implementations of the method, it may include generating, based on stored credit application status results, analytics relating to a plurality of credit applications including one or more of performance, statistics, approval rates and delays.

In some implementations of the method, it may include, for a first credit application currently assigned to a first underwriter, automatically re-assigning the first credit application to a second underwriter based on stored credit application status results associated with either the first underwriter or the second underwriter.

In some implementations of the method, it may include analyzing the stored credit application status results with respect to a plurality of sales representatives to determine deal volume, deal results, or percent approval.

In some implementations of the method, it may include generating performance data including one or more performance enhancement prompts based on the analyzed stored credit application status results.

In some implementations of the method, the pending credit application may be associated with a real estate secured lending mortgage. In some implementations of the method, automatically generating the status of the pending credit application may include determining whether the adjudication process is complete for the pending credit application.

In some implementations of the method, the pending credit application may be associated with a retail risk management. In some implementations of the method, automatically generating the status of the pending credit application may include determining whether the credit application is with RRM or whether the credit application is with RRM but assigned to a credit analyst.

Yet another aspect of the present disclosure relates to a non-transient computer-readable storage medium having instructions embodied thereon, the instructions being executable by one or more processors to perform a method for processing instructions associated with one or more data transfers. The method may include obtaining, by a processor, a credit application identifier identifying a pending credit application that involves credit adjudication. The method may include identifying, in conjunction with an adjudication database and based on the credit application identifier, an adjudication process identifier associated with ownership of a current adjudication task for the pending credit application. The method may include automatically generating, based on a role associated with the adjudication process identifier, a status of the pending credit application. The method may include providing, by the processor, the status of the pending credit application.

In some implementations of the computer-readable storage medium, the method may include automatically generating the status of the pending credit application based on the role associated with the adjudication process identifier and on the ownership of the current adjudication task.

In some implementations of the computer-readable storage medium, the method may include automatically generating the status of the pending credit application based on blending data from an adjudication database with the adjudication process identifier.

In some implementations of the computer-readable storage medium, the method may include providing a visual overview of the status of the pending credit application to a computing device associated with a sales representative involved with the credit application.

In some implementations of the computer-readable storage medium, the method may include providing a visual overview of the status of the pending credit application to a computing device associated with an applicant involved with the credit application.

In some implementations of the computer-readable storage medium, the method may include providing near real-time access to the status of the pending credit application including access to details associated with the status.

In some implementations of the computer-readable storage medium, the method may include providing a display including a rush request button configured to receive a request to rush the pending credit application currently being viewed.

In some implementations of the computer-readable storage medium, the method may include managing data access permissions associated with the status of the pending credit application. In some implementations of the computer-readable storage medium, the method may include providing a user interface including the status of the pending credit application and based on the data access permissions.

In some implementations of the computer-readable storage medium, the method may include displaying the status of a plurality of pending credit applications associated with one or more of a user, a branch, a district, or a region.

In some implementations of the computer-readable storage medium, the method may include providing a current wait time calendar indicating wait times associated with the plurality of pending credit applications.

In some implementations of the computer-readable storage medium, the user may include a financial institution sales representative, a financial institution manager, or a mortgage broker.

In some implementations of the computer-readable storage medium, the method may include providing a user interface via which the status of a plurality of pending credit applications may be filtered by one or more filtering factors such as deal type, complexity and rush.

In some implementations of the computer-readable storage medium, the method may include obtaining data associated with the pending credit application from one or more data sources.

In some implementations of the computer-readable storage medium, the method may include automatically determining the status of the pending credit application based on the role associated with the adjudication process identifier and based on one or more of a compliance process identifier associated with ownership of a current compliance task for the pending credit application and an appraisal process identifier associated with ownership of a current appraisal task for the pending credit application.

In some implementations of the computer-readable storage medium, the method may include generating, based on stored credit application status results, analytics relating to a plurality of credit applications including one or more of performance, statistics, approval rates and delays.

In some implementations of the computer-readable storage medium, the method may include, for a first credit application currently assigned to a first underwriter, automatically re-assigning the first credit application to a second underwriter based on stored credit application status results associated with either the first underwriter or the second underwriter.

In some implementations of the computer-readable storage medium, the method may include analyzing the stored credit application status results with respect to a plurality of sales representatives to determine deal volume, deal results, or percent approval.

In some implementations of the computer-readable storage medium, the method may include generating performance data including one or more performance enhancement prompts based on the analyzed stored credit application status results.

In some implementations of the computer-readable storage medium, the pending credit application may be associated with a real estate secured lending mortgage. In some implementations of the computer-readable storage medium, automatically generating the status of the pending credit application may include determining whether the adjudication process is complete for the pending credit application.

In some implementations of the computer-readable storage medium, the pending credit application may be associated with a retail risk management. In some implementations of the computer-readable storage medium, automatically generating the status of the pending credit application may include determining whether the credit application is with RRM or whether the credit application is with RRM but assigned to a credit analyst.

Still another aspect of the present disclosure relates to a system configured for processing instructions associated with one or more data transfers. The system may include means for obtaining, by a processor, a credit application identifier identifying a pending credit application that involves credit adjudication. The system may include means for identifying, in conjunction with an adjudication database and based on the credit application identifier, an adjudication process identifier associated with ownership of a current adjudication task for the pending credit application. The system may include means for automatically generating, based on a role associated with the adjudication process identifier, a status of the pending credit application. The system may include means for providing, by the processor, the status of the pending credit application.

In some implementations of the system, the system may include means for automatically generating the status of the pending credit application based on the role associated with the adjudication process identifier and on the ownership of the current adjudication task.

In some implementations of the system, the system may include means for automatically generating the status of the pending credit application based on blending data from an adjudication database with the adjudication process identifier.

In some implementations of the system, the system may include means for providing a visual overview of the status of the pending credit application to a computing device associated with a sales representative involved with the credit application.

In some implementations of the system, the system may include means for providing a visual overview of the status of the pending credit application to a computing device associated with an applicant involved with the credit application.

In some implementations of the system, the system may include means for providing near real-time access to the status of the pending credit application including access to details associated with the status.

In some implementations of the system, the system may include means for providing a display including a rush request button configured to receive a request to rush the pending credit application currently being viewed.

In some implementations of the system, the system may include means for managing data access permissions associated with the status of the pending credit application. In some implementations of the system, the system may include means for providing a user interface including the status of the pending credit application and based on the data access permissions.

In some implementations of the system, the system may include means for displaying the status of a plurality of pending credit applications associated with one or more of a user, a branch, a district, or a region.

In some implementations of the system, the system may include means for providing a current wait time calendar indicating wait times associated with the plurality of pending credit applications.

In some implementations of the system, the user may include a financial institution sales representative, a financial institution manager, or a mortgage broker.

In some implementations of the system, the system may include means for providing a user interface via which the status of a plurality of pending credit applications may be filtered by one or more filtering factors such as deal type, complexity and rush.

In some implementations of the system, the system may include means for obtaining data associated with the pending credit application from one or more data sources.

In some implementations of the system, the system may include means for automatically determining the status of the pending credit application based on the role associated with the adjudication process identifier and based on one or more of a compliance process identifier associated with ownership of a current compliance task for the pending credit application and an appraisal process identifier associated with ownership of a current appraisal task for the pending credit application.

In some implementations of the system, the system may include means for generating, based on stored credit application status results, analytics relating to a plurality of credit applications including one or more of performance, statistics, approval rates and delays.

In some implementations of the system, the system may include means for, for a first credit application currently assigned to a first underwriter, automatically re-assigning the first credit application to a second underwriter based on stored credit application status results associated with either the first underwriter or the second underwriter.

In some implementations of the system, the system may include means for analyzing the stored credit application status results with respect to a plurality of sales representatives to determine deal volume, deal results, or percent approval.

In some implementations of the system, the system may include means for generating performance data including one or more performance enhancement prompts based on the analyzed stored credit application status results.

In some implementations of the system, the pending credit application may be associated with a real estate secured lending mortgage. In some implementations of the system, automatically generating the status of the pending credit application may include determining whether the adjudication process is complete for the pending credit application.

In some implementations of the system, the pending credit application may be associated with a retail risk management. In some implementations of the system, automatically generating the status of the pending credit application may include determining whether the credit application is with RRM or whether the credit application is with RRM but assigned to a credit analyst.

Even another aspect of the present disclosure relates to a computing platform configured for processing instructions associated with one or more data transfers. The computing platform may include a non-transient computer-readable storage medium having executable instructions embodied thereon. The computing platform may include one or more hardware processors configured to execute the instructions. The processor(s) may execute the instructions to obtain, by a processor, a credit application identifier identifying a pending credit application that involves credit adjudication. The processor(s) may execute the instructions to identify, in conjunction with an adjudication database and based on the credit application identifier, an adjudication process identifier associated with ownership of a current adjudication task for the pending credit application. The processor(s) may execute the instructions to automatically generate, based on a role associated with the adjudication process identifier, a status of the pending credit application. The processor(s) may execute the instructions to provide, by the processor, the status of the pending credit application.

In some implementations of the computing platform, the processor(s) may execute the instructions to automatically generate the status of the pending credit application based on the role associated with the adjudication process identifier and on the ownership of the current adjudication task.

In some implementations of the computing platform, the processor(s) may execute the instructions to automatically generate the status of the pending credit application based on blending data from an adjudication database with the adjudication process identifier.

In some implementations of the computing platform, the processor(s) may execute the instructions to provide a visual overview of the status of the pending credit application to a computing device associated with a sales representative involved with the credit application.

In some implementations of the computing platform, the processor(s) may execute the instructions to provide a visual overview of the status of the pending credit application to a computing device associated with an applicant involved with the credit application.

In some implementations of the computing platform, the processor(s) may execute the instructions to provide near real-time access to the status of the pending credit application including access to details associated with the status.

In some implementations of the computing platform, the processor(s) may execute the instructions to provide a display including a rush request button configured to receive a request to rush the pending credit application currently being viewed.

In some implementations of the computing platform, the processor(s) may execute the instructions to manage data access permissions associated with the status of the pending credit application. In some implementations of the computing platform, the processor(s) may execute the instructions to provide a user interface including the status of the pending credit application and based on the data access permissions.

In some implementations of the computing platform, the processor(s) may execute the instructions to display the status of a plurality of pending credit applications associated with one or more of a user, a branch, a district, or a region.

In some implementations of the computing platform, the processor(s) may execute the instructions to provide a current wait time calendar indicating wait times associated with the plurality of pending credit applications.

In some implementations of the computing platform, the user may include a financial institution sales representative, a financial institution manager, or a mortgage broker.

In some implementations of the computing platform, the processor(s) may execute the instructions to provide a user interface via which the status of a plurality of pending credit applications may be filtered by one or more filtering factors such as deal type, complexity and rush.

In some implementations of the computing platform, the processor(s) may execute the instructions to obtain data associated with the pending credit application from one or more data sources.

In some implementations of the computing platform, the processor(s) may execute the instructions to automatically determine the status of the pending credit application based on the role associated with the adjudication process identifier and based on one or more of a compliance process identifier associated with ownership of a current compliance task for the pending credit application and an appraisal process identifier associated with ownership of a current appraisal task for the pending credit application.

In some implementations of the computing platform, the processor(s) may execute the instructions to generate, based on stored credit application status results, analytics relating to a plurality of credit applications including one or more of performance, statistics, approval rates and delays.

In some implementations of the computing platform, the processor(s) may execute the instructions to, for a first credit application currently assigned to a first underwriter, automatically re-assign the first credit application to a second underwriter based on stored credit application status results associated with either the first underwriter or the second underwriter.

In some implementations of the computing platform, the processor(s) may execute the instructions to analyze the stored credit application status results with respect to a plurality of sales representatives to determine deal volume, deal results, or percent approval.

In some implementations of the computing platform, the processor(s) may execute the instructions to generate performance data including one or more performance enhancement prompts based on the analyzed stored credit application status results.

In some implementations of the computing platform, the pending credit application may be associated with a real estate secured lending mortgage. In some implementations of the computing platform, automatically generating the status of the pending credit application may include determining whether the adjudication process is complete for the pending credit application.

In some implementations of the computing platform, the pending credit application may be associated with a retail risk management. In some implementations of the computing platform, automatically generating the status of the pending credit application may include determining whether the credit application is with RRM or whether the credit application is with RRM but assigned to a credit analyst.

What is claimed is:

1. A computing device configured to process instructions associated with one or more data transfers, the computing device comprising:
a non-transient computer-readable storage medium having executable instructions embodied thereon; and
one or more hardware processors configured to execute the instructions to:
obtain, by a processor, a credit application identifier identifying a pending credit application that involves credit adjudication;
identify, in conjunction with an adjudication database and based on the credit application identifier, an adjudication process identifier associated with ownership of a current adjudication task for the pending credit application;
automatically generate, based on a role associated with the adjudication process identifier, a status of the pending credit application; and
provide, by the processor, the status of the pending credit application.

2. The computing device of claim 1 wherein the one or more hardware processors are further configured to execute the instructions to:
automatically generate the status of the pending credit application based on the role associated with the adjudication process identifier and on the ownership of the current adjudication task.

3. The computing device of claim 1 wherein the one or more hardware processors are further configured to execute the instructions to:
automatically generate the status of the pending credit application based on blending data from an adjudication database with the adjudication process identifier.

4. The computing device of claim 1 wherein the one or more hardware processors are further configured to execute the instructions to:
display the status of a plurality of pending credit applications associated with one or more of a user, a branch, a district, or a region.

5. The computing device of claim 1 wherein the one or more hardware processors are further configured to execute the instructions to:
provide a user interface via which the status of a plurality of pending credit applications may be filtered by one or more filtering factors, such as deal type, complexity and rush.

6. The computing device of claim 1 wherein the one or more hardware processors are further configured to execute the instructions to:
automatically determine the status of the pending credit application based on the role associated with the adjudication process identifier and based on one or more of:
a compliance process identifier associated with ownership of a current compliance task for the pending credit application; and
an appraisal process identifier associated with ownership of a current appraisal task for the pending credit application.

7. The computing device of claim 1 wherein the one or more hardware processors are further configured to execute the instructions to:
generate, based on stored credit application status results, analytics relating to a plurality of credit applications including one or more of performance, statistics, approval rates and delays.

8. The computing device of claim 7 wherein the one or more hardware processors are further configured to execute the instructions to:
for a first credit application currently assigned to a first underwriter, automatically reassign the first credit application to a second underwriter based on stored credit application status results associated with either the first underwriter or the second underwriter.

9. The computing device of claim 7 wherein the one or more hardware processors are further configured to execute the instructions to:
analyze the stored credit application status results with respect to a plurality of sales representatives to determine deal volume, deal results, or percent approval.

10. The computing device of claim 1 wherein the one or more hardware processors are further configured to execute the instructions to:
provide a display including a rush request button configured to receive a request to rush the pending credit application currently being viewed.

11. A computer-implemented method for processing instructions associated with one or more data transfers, the method comprising:
obtaining, by a processor, a credit application identifier identifying a pending credit application that involves credit adjudication;
identifying, in conjunction with an adjudication database and based on the credit application identifier, an adjudication process identifier associated with ownership of a current adjudication task for the pending credit application;
automatically generating, based on a role associated with the adjudication process identifier, a status of the pending credit application; and
providing, by the processor, the status of the pending credit application.

12. The method of claim 11 further comprising:
automatically generating the status of the pending credit application based on the role associated with the adjudication process identifier and on the ownership of the current adjudication task.

13. The method of claim 11 further comprising:
automatically generating the status of the pending credit application based on blending data from an adjudication database with the adjudication process identifier.

14. The method of claim 11 further comprising:
displaying the status of a plurality of pending credit applications associated with one or more of a user, a branch, a district, or a region.

15. The method of claim 11 further comprising:
providing a user interface via which the status of a plurality of pending credit applications may be filtered by one or more filtering factors, such as deal type, complexity and rush.

16. The method of claim 11 further comprising:
automatically determining the status of the pending credit application based on the role associated with the adjudication process identifier and based on one or more of:
a compliance process identifier associated with ownership of a current compliance task for the pending credit application; and
an appraisal process identifier associated with ownership of a current appraisal task for the pending credit application.

17. The method of claim 11 further comprising:
generating, based on stored credit application status results, analytics relating to a plurality of credit applications including one or more of performance, statistics, approval rates and delays.

18. The method of claim 17 further comprising:
for a first credit application currently assigned to a first underwriter, automatically reassigning the first credit application to a second underwriter based on stored credit application status results associated with either the first underwriter or the second underwriter.

19. The method of claim 17 further comprising:
analyzing the stored credit application status results with respect to a plurality of sales representatives to determine deal volume, deal results, or percent approval.

20. A non-transient computer-readable storage medium having instructions embodied thereon, the instructions being executable by one or more processors to perform a method for providing data access, the method comprising:
obtaining, by a processor, a credit application identifier identifying a pending credit application that involves credit adjudication;
identifying, in conjunction with an adjudication database and based on the credit application identifier, an adjudication process identifier associated with ownership of a current adjudication task for the pending credit application;
automatically generating, based on a role associated with the adjudication process identifier, a status of the pending credit application; and
providing, by the processor, the status of the pending credit application.
